(19) United States
(12) Patent Application Publication
(10) Pub. No.: US 2010/0237104 A1
(43) Pub. Date: Sep. 23, 2010

(54) Cove Base Nozzle for Dispensing Applications

(76) Inventors: Mark C. Schneider, Moorestown, NJ (US); Brian J. MacKenzie, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/724,025

(22) Filed: Mar. 15, 2010

Related U.S. Application Data
(60) Provisional application No. 61/160,853, filed on Mar. 17, 2009.

(51) Int. Cl. B65D 88/54; B05C 17/01; B65D 47/00; B05C 21/00

(52) U.S. Cl. 222/330; 222/1; 222/566

(57) ABSTRACT

A nozzle is disclosed for dispensing viscous material comprising a plurality of dispensing tubes having dispensing tips and a single input cavity adapted to accept the viscous material. In an embodiment, at least one of the dispensing tips is manufactured closed and can be opened at the user's discretion. In a further embodiment, the nozzle has a flange at the input tube end, and the flange holds the nozzle between a dispensing tool end-stop and a material container, such as the tip of a tube of adhesive or sealant. In an embodiment, the dispensing tubes are at an angle to the centerline of the material dispenser.

In a further embodiment, the nozzle screws into to a threaded socket on a dispensing tool by a thread on the outside of the input tube.

### RELATED APPLICATIONS

This application claims the benefit of U.S. provisional application No. 61/160,853 filed on Mar. 17, 2009.

### BACKGROUND OF THE INVENTION

This invention relates generally to a nozzle for a handheld dispensing tool, and more specifically to a nozzle for a dispensing tool employed to dispense viscous materials such as gluing and sealing materials and the like.

### BACKGROUND

Devices for dispensing viscous materials such as caulk and various construction adhesives are well known in the art. In general, these devices incorporate an elongate cylindrical barrel containing the material to be dispensed and a plunger/piston which is moved through the barrel by manual or powered means to force the material to be dispensed out of a nozzle at one end of the barrel. In caulking applications, a single nozzle emits a stream of caulk that can be readily directed to a crevice to be sealed. The same type of dispenser is also regularly used for application of construction adhesives. In many of these applications, multiple beads of adhesive are applied to the parts to be joined, where the surface area of the parts is large enough to require more than a single bead for adequate coverage and adhesion. A nozzle that emits multiple beads simultaneously increases application speed and provides a uniform separation distance between beads. Increased application speed ensures that, in the case of an adhesive, the amount of time that the adhesive is exposed to the air before the parts to be joined are affixed is reduced, thus improving adhesion and allowing for more uniform adhesion across large work areas. Nozzles with multiple dispensing outlets are known for this purpose. Not all applications, however, require as many beads of material as are available in presently available multi-tipped application nozzles, which typically have three or five outlets.

Therefore, there exists a need for a multi-tipped application nozzle for viscous materials wherein the user can select which tips are active and which do not eject material. Also, there exists a need for a multi-tipped application nozzle wherein the user can control the size of the nozzle opening to control the amount of the material to be dispensed.

All references cited herein are incorporated by reference in their entireties.

### BRIEF SUMMARY OF THE INVENTION

A nozzle is disclosed for dispensing viscous material comprising a plurality of dispensing tubes having dispensing tips and a single input cavity adapted to accept the viscous material. In an embodiment, at least one of the dispensing tips is manufactured closed and can be opened at the user's discretion. In a further embodiment, the nozzle input cavity is adapted to accept a single nozzle from a material container. In a further embodiment, the nozzle has a flange at the input tube end, and the flange holds the nozzle between a dispensing tool end-stop and a material container, such as the tip of a tube of adhesive or sealant. In an embodiment, the dispensing tubes are at an angle to the centerline of the material dispenser.

In a further embodiment, the nozzle screws into a threaded socket on a dispensing tool by a thread on the outside of the input tube.

### BRIEF DESCRIPTION OF SEVERAL VIEWS OF THE DRAWINGS

The invention will be described in conjunction with the following drawings in which like reference numerals designate like elements and wherein:

FIG. 1 is a drawing of an exemplary multi-tip nozzle of the present invention in use;

FIG. 2 is a drawing of an exemplary multi-tip nozzle of the present invention with two tips cut open for dispensing material;

FIG. 3 is a sectional view taken along line 3-3 of FIG. 2;

FIG. 4 is a sectional view taken along line 4-4 of FIG. 2;

FIG. 5 is drawing of an alternate embodiment of a multi-tip nozzle; and,

FIG. 6 is a sectional view taken along line 6-6 of FIG. 5.

### DETAILED DESCRIPTION OF THE INVENTION

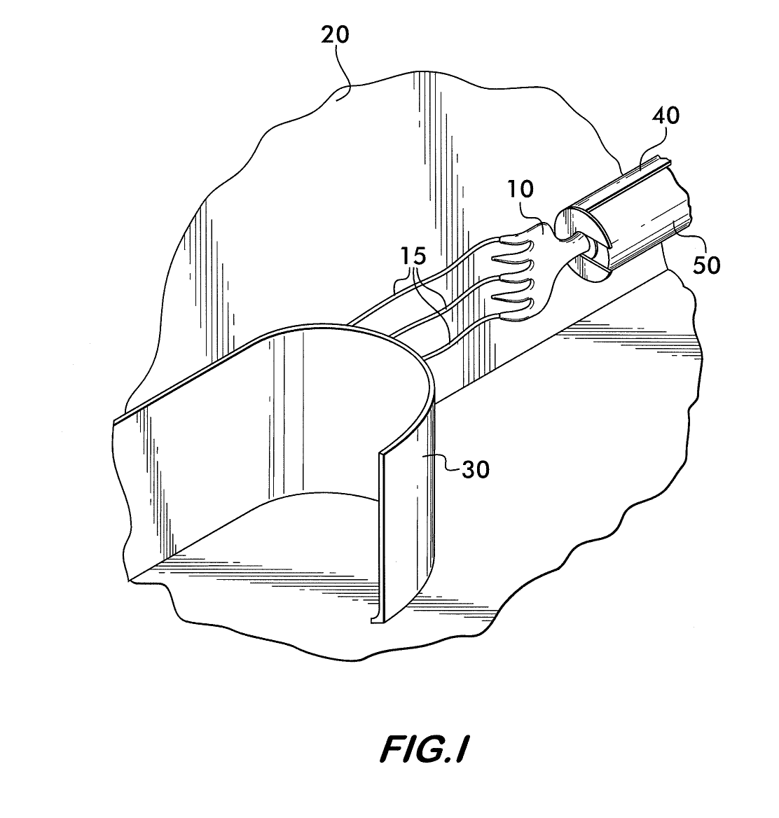

FIG. 1 shows an exemplary multi-tipped nozzle 10 applying three beads of material 15 to a surface 20 to which a flexible covering 30 is to be affixed. A typical use of the multi-tipped nozzle 10 is application of material 15, e.g., adhesive, for installing cove base molding 30. Referring now to FIGS. 1-4, the nozzle 10 is shown in use attached to a dispensing device, partially shown at 40. A hard cartridge, partially shown at 50, containing material 15 to be dispensed is shown housed within the dispensing device 40. The hard cartridge 50 that is used in conjunction with such dispensing devices 40 is of a standard size and configuration and comprises a front wall 31, a back wall (not shown), and tubular body portion containing material therein to be dispensed. A hard cup-shaped movable plunger (not shown) is located at the rearward end of the hard cartridge 50. The hard cartridge 50 includes its own dispensing nozzle 33 located at the forward end thereof. As best shown in FIG. 3, the dispensing nozzle 33 of the hard cartridge 50 extends through an opening located in an end plate 41 at the front end of the dispensing device 40. The moveable plunger provides means for the dispensing device 40 to apply dispensing pressure to the material within the cartridge 50. When the cartridge 50 is appropriately registered within the dispensing device 40, the moveable plunger is arranged to be moved in a forward ejecting direction towards the cartridge dispensing nozzle 33 to expel material from the cartridge 50.

As shown in FIG. 1, three of the five tips of the multi-tipped nozzle 10 are open and emitting material, and two of the tips remain closed.

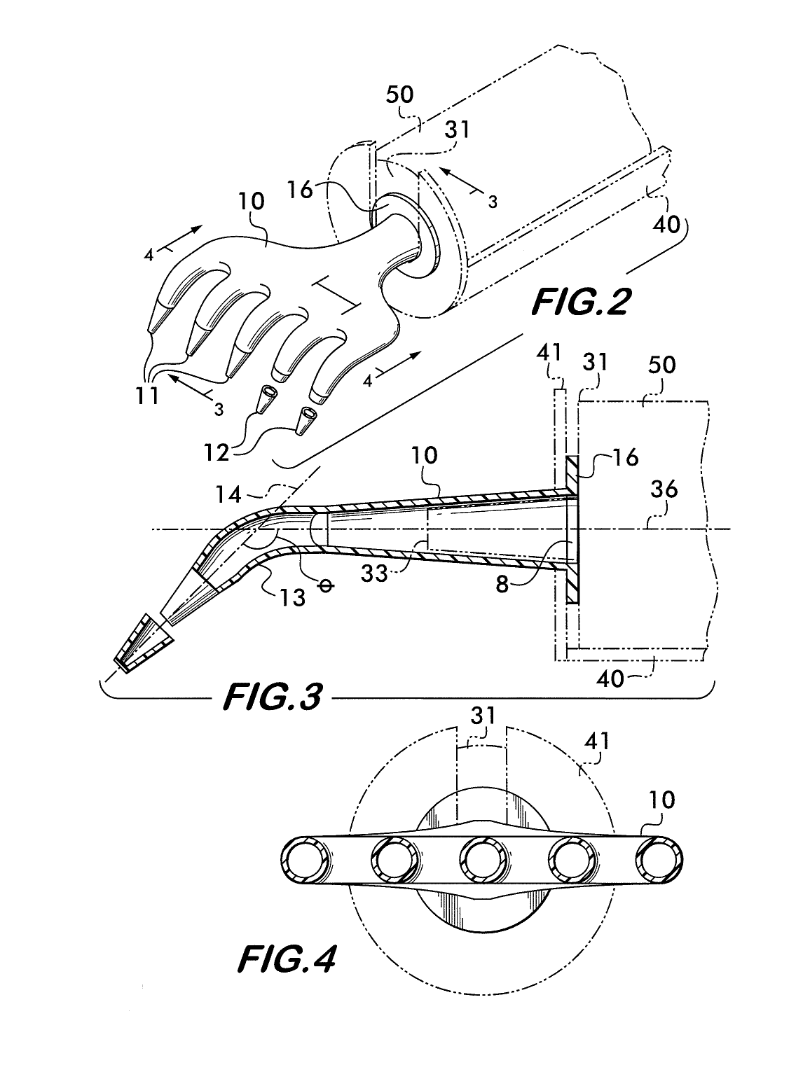

FIG. 2 shows a multi-tipped nozzle 10 similar to the one shown FIG. 1. As shown in FIG. 2, three nozzle tips 11 remain in place over nozzle tubes 13 to prevent material 15 from being dispensed through those nozzle tubes, while two nozzle tips 12 have been cut to open those two nozzle tips 12 to allow material 15 to be dispensed therefrom. In an exemplary embodiment, the multi-tipped nozzle 10 is blow-molded high density polyethylene and the nozzle tips 12 are easily removed with a knife. In alternate embodiments (not shown), the nozzle tips are threaded and can be removed and replaced for applications where, for instance, the multi-tipped nozzle 10 will be used more than once.

Referring now to FIG. 3, each of the nozzle tubes 13 of the multi-tipped nozzle 10 is bent, placing the centerline 14 of the tips 11 and 12 at an oblique angle θ to the centerline 36 of the hard cartridge 50. While the invention encompasses both straight nozzle tubes and bent tubes 13, the configuration shown in FIGS. 1-3 is especially useful in that it provides a more comfortable positioning of the dispensing device 40 relative to the surface 20 on which the material 15 is to be applied, e.g., a vertical wall surface. The bent tubes 13 also afford easier access to tight areas that might not be accessible with straight tubes.

FIG. 3 clearly shows how, in this exemplary embodiment, the multi-tipped nozzle 10 includes a flange 16 that is sandwiched between the end plate 41 of the dispensing device 40 and the front wall 31 of the hard cartridge 50. FIG. 3 also shows the nozzle 33 of the hard cartridge 50 extending through a front opening in the dispensing device 40 and into the multi-tip nozzle 10. The force of the plunger (not shown) that forces material through the hard cartridge 50 forces the front wall 31 of the hard cartridge 50 against the nozzle flange 16, which is in turn forced against the end plate 41 of the dispensing device 40, thus holding the nozzle 10 firmly in place with respect to both the dispensing device 40 and the hard cartridge 50. FIG. 4 is a cross section view of the nozzle 10 taken at section lines labeled 4 in FIG. 2.

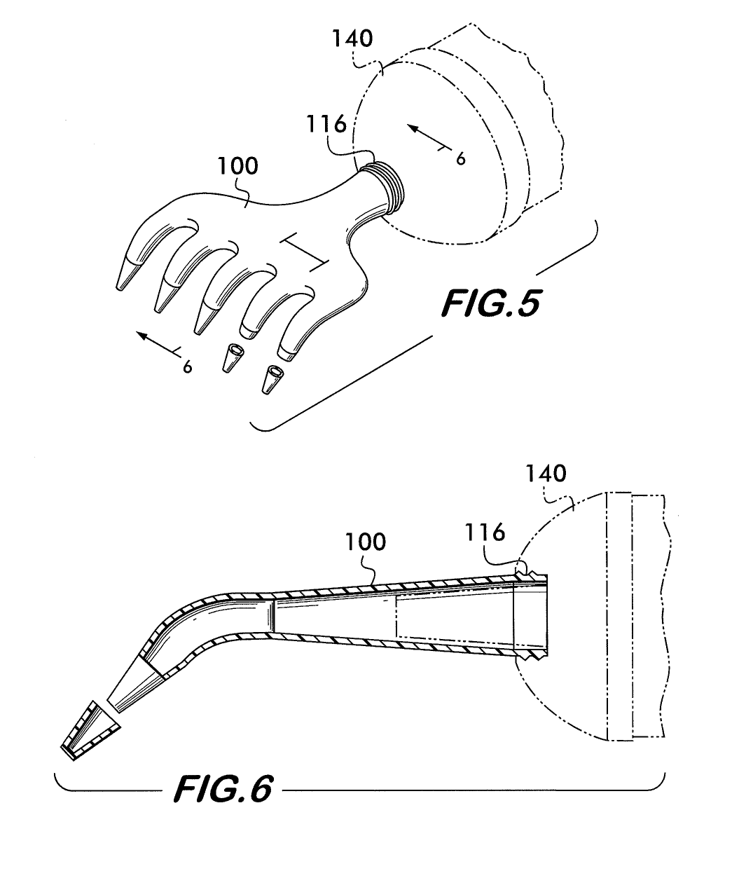

In an alternate embodiment, shown in FIGS. 5 and 6, the nozzle 100 has external threads 116 at the inlet end that mate with internal threads (not shown) on the dispensing device 140. In this embodiment, the nozzle 100 is screwed into the end of the dispensing device 140. One application where this is practical is for dispensing devices adapted to accept bulk material not contained in a separate tube with a nozzle or for so-called “sausage” containers of material that do not have nozzles and which are simply opened at one end and the material forced out of the dispensing device, which comprises a complete cylinder with a plunger at one end and a threaded hole to accept the nozzle at the other end. Other types of nozzle-to-dispenser attachment means are also possible within the scope of the invention, including snap fit and twist and lock type fits.

While the invention has been described in detail and with reference to specific examples thereof, it will be apparent to one skilled in the art that various changes and modifications can be made therein without departing from the spirit and scope thereof.

What is claimed is:

1. A nozzle for dispensing viscous material comprising a plurality of dispensing tubes having dispensing tips and a single input cavity adapted to accept the viscous material, wherein at least one of said dispensing tips is closed and can be opened at the user's discretion

2. The nozzle of claim 1, wherein said dispensing tips are adapted to be opened at user-selectable opening sizes.

3. The nozzle of claim 1 wherein said input cavity is adapted to accept a single nozzle from a material container.

4. The nozzle of claim 3 further comprising a flange at said input cavity, said flange being adapted to hold the nozzle between a dispensing tool end stop and said material container.

5. The nozzle of claim 1, wherein said dispensing tubes have dispensing tube centerlines, said input cavity has an input cavity centerline and said dispensing tube centerlines and input cavity centerline are in a single plane.

6. The nozzle of claim 1, wherein said dispensing tubes have dispensing tube centerlines, said input cavity has an input cavity centerline and said dispensing tube centerlines are in a single dispensing tube plane and said dispensing tube plane is at an oblique angle to said input cavity centerline.

7. The nozzle of claim 1 further comprising an external thread at said input cavity, said external thread adapted to mate with an internal thread of a material dispenser or a dispensing tool.

8. The nozzle of claim 1 wherein said dispensing tubes have a circular cross section.

9. The nozzle of claim 1, having at least two dispensing tubes and dispensing tips and wherein said dispensing tips are equally spaced.

10. The nozzle of claim 1, having five tips.

11. The nozzle of claim 2, wherein said dispensing tips are opened by cutting off a portion of said dispensing tip.

12. The nozzle of claim 2, wherein said dispensing tips are opened by removing replaceable tips.

13. A method of applying an extrudable material to a surface in multiple beads with an applicator adapted for extruding as many as a fixed number of beads, said method comprising:
a. selecting a number of beads to be applied, said number being equal to or less than said fixed number of beads;
b. opening delivery ports in said applicator for the selected number of beads; and,
c. extruding material through said opened delivery ports.
